(19) United States
(12) Patent Application Publication
(10) Pub. No.: US 2016/0131015 A1
(43) Pub. Date: May 12, 2016

(54) METHOD FOR IMPROVING APPEARANCE OF DIESEL PARTICULATE FILTERS

(71) Applicant: Caterpillar Inc., Peoria, IL (US)

(72) Inventor: Steven F. Meister, Chillicothe, IL (US)

(73) Assignee: Caterpillar Inc., Peoria, IL (US)

(21) Appl. No.: 14/981,976

(22) Filed: Dec. 29, 2015

(51) Int. Cl. F01N 13/18; B23K 26/21; B23K 9/16; F01N 3/021

(52) U.S. Cl. CPC F01N 13/1872; F01N 3/021; B23K 26/21; B23K 9/16

(57) ABSTRACT

A method of repairing an outer enclosure of a diesel particulate filter, having a first axial end and a second axial end, is disclosed. The method includes wrapping a generally planar metal sheet around the outer enclosure. The generally planar metal sheet has a first lateral edge, a second lateral edge, a first longitudinal edge, and a second longitudinal edge. Thereafter, aligning a first longitudinal edge with the first axial end and the second longitudinal edge with the second axial end is carried out. Next, causing one of an abutment or an overlap of the first lateral edge with the second lateral edge is performed. Lastly, joining the first longitudinal edge to the first axial end, the second longitudinal edge to the second axial end, and the first lateral edge with the second lateral edge along an axial length of the outer enclosure is performed by welding.

### TECHNICAL FIELD

The present disclosure generally relates to Diesel Particulate Filters (DPFs) applied in aftertreatment systems of power systems such as internal combustion engines. More particularly, the present disclosure relates to a method of repairing and improving surface distortions on an outer surface of the DPFs.

### BACKGROUND

Power systems in machines, such as diesel engines (or simply engines), are typically provided with aftertreatment systems that ensure effective treatment and reduction of air pollutants, such as nitrogen oxides (NOx), solid particulate matter, also known as soot, etc., that accompany a release of exhaust gases into the atmosphere. To this end, aftertreatment systems usually include a set of components, such as selective catalytic reduction (SCR) modules, diesel particulate filters (DPF), reductant delivery systems, etc., that in concert facilitate treatment of a stream of exhaust air, before it is vented out.

DPFs play a generally significant role in treating the exhaust mixture from engines of machines by removing soot from an exhaust gas stream. Given continued usage, DPFs need to be cleaned at regular intervals. Such cleaning is performed by oxidizing or charring the blocked soot in annular passages of the DPFs. Typically, during regeneration, service, and repair of the DPFs, DPF enclosures may develop surface irregularities such as dents, distortions, deformations, aberrations, and discoloration. Although, measures are assumed to rectify shape distortions, dents, and dings, it is quite difficult to return the aesthetic appeal held by the original design. One reason for such a difficulty is that DPF enclosures are generally only selectively accessible from the inside, minimizing chances for an operator to access the dent from the inside and push the dent outwards to restore the enclosure to its original shape.

One common measure applied to remove dents includes temporarily attaching a fixture to a dent portion by welding, for example. Thereafter, a pulling force is applied in an opposite direction to return the dent portion to the original state. However, as has been frequently observed, a surface finish of the final product remains dotted with surface irregularities, weld marks, and an unappealing surface finish, probably defined by dent contours, etc. As a result, an overall aesthetic appeal of the DPF is reduced, potentially affecting a customer base.

U.S. Pat. No. 5,226,581 discloses the reclamation of components of filtration devices. However, the '581 reference is focused towards retrofitting a metal fiber felt found in polymer filtration devices. Moreover, there is no discussion pertaining to returning an aesthetical appeal of remanufactured components or enclosures, and which may be suited for resale.

Accordingly, the system and method of the present disclosure solves one or more problems set forth above and other problems in the art.

### SUMMARY OF THE INVENTION

Various aspects of the present disclosure illustrate a method of repairing an outer enclosure of a diesel particulate filter. The outer enclosure has selective inward access. Structurally, the outer enclosure has a first axial end and a second axial end. The method includes wrapping a generally planar metal sheet around the outer enclosure. The generally planar metal sheet conforms to a surface area of the outer enclosure and has a sheet periphery with a first lateral edge, a second lateral edge, a first longitudinal edge, and a second longitudinal edge. Thereafter, the method includes aligning the first longitudinal edge of the metal sheet with the first axial end of the enclosure, and the second longitudinal edge of the metal sheet with the second axial end of the enclosure. Next, causing one of an abutment or an overlap of the first lateral edge with the second lateral edge.

Lastly, joining is performed of the first longitudinal edge of the metal sheet to the first axial end of enclosure, the second longitudinal edge of the metal sheet to the second axial end of the enclosure, and the first lateral edge of the metal sheet with the second lateral edge of the metal sheet. This joining is performed along an axial length of the outer enclosure, and is performed by a welding process.

### BRIEF DESCRIPTION OF THE DRAWINGS

FIG. 1 is an engine system with an emission cleaning module, in accordance with the concepts of the present disclosure;

FIG. 2 is a perspective view of a Diesel Particulate Filter (DPF) applied within the emission cleaning module of FIG. 1, with a planarly shaped sheet metal being in position to be wrapped around an outer enclosure of the DPF, in accordance with the concepts of the present disclosure;

FIG. 3 is a perspective view of the DPF, with the planarly shaped sheet metal of FIG. 2 being wrapped around the outer enclosure and the outer enclosure having been aesthetically repaired, in accordance with the concepts of the present disclosure; and

FIG. 4 is a flowchart depicting an exemplary method of an aesthetic treatment of the DPF enclosure, in accordance with the concepts of the present disclosure.

### DETAILED DESCRIPTION

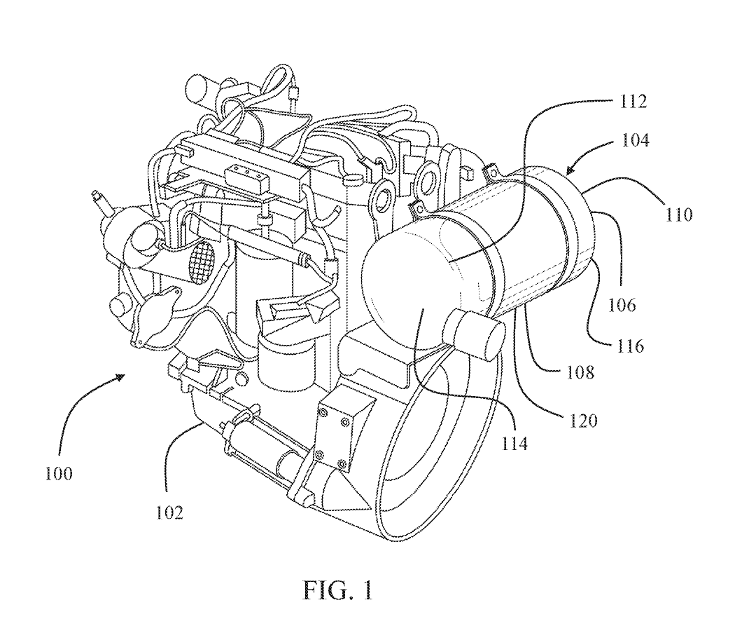

Referring to FIG. 1, there is shown an engine system 100. The engine system 100 may be applied in construction machines, such as mining trucks, off-highway trucks, wheel loaders, excavators, dozers, compactors, etc. An application of the aspects of the present disclosure may also extend to engine systems employed in multiple environments, such that of power generation units involving stationary generator sets, etc. Further, power generation systems in commercial and domestic establishments may suitably apply one or more aspects disclosed herein as well. The engine system 100 includes an engine 102 and an exhaust cleaning module 104.

The exhaust cleaning module 104 is an aftertreatment system used to treat exhaust gases resulting from combustion in the engine 102, prior to its emission into the environment. As is conventionally known, the exhaust cleaning module 104 includes a selective catalyst reduction (SCR) module (not shown) in fluid communication with a diesel particulate filter (DPF) 106, via mixing chambers (not shown). A Diesel Emission Fluid may be used as a consumable to lower NOx concentration in the diesel exhaust emissions.

The DPF 106 is generally positioned to receive a diesel emission outflow from exhaust ports of the engine 102 and filter out the flow of particulate matter, also referred to as soot. The DPF 106 includes an outer enclosure 108 that houses a cored structure (not shown). The cored structure may be constituted by a ceramic material, for example, to resonate a profile that traps and restricts the soot from flowing further into the mixing chamber, along an associated emission flow path. The DPF 106 includes a substantially elongated structure, as shown, characterized by a cylindrical profile. Depending upon need and engine configuration, this elongated profile may vary and a shortened or a lengthened DPF 106 may be employed. Nonetheless, this characteristic profile of the DPF 106 is contributed primarily by the outer enclosure 108 of the DPF 106, although various other profiles of the outer enclosure 108, such as those defined by an elongated cuboidal profile, an elliptical profile, etc., may be contemplated. Generally, a position of the DPF 106 is assumed outwardly to the engine 102, as shown, from where an aesthetic appeal and a fit and finish of the DPF 106 is bound to be analysed by operators, servicemen, and customers. The outer enclosure 108 of the DPF 106 has a first axial end 110 and a second axial end 112.

The DPF 106 has selective inward access to the affect that either ends 110 and 112 of the outer enclosure 108 of are closed by end caps. These end caps are classified into a first end cap 114 and a second end cap 116 that are respectively positioned and retained at the first axial end 110 and the second axial end 112. A closure at the ends 110 and 112 generally restricts a ready access to the insides of the DPF 106 by operators or servicemen, and which also suffice to restrict the DPF 106 from an interference with the outside environment, during operations and general service, for example. Retention of the first end cap 114 and the second end cap 116 to the first axial end 110 and the second axial end 112 of the outer enclosure 108 may be attained by threadable fastening, for example. To this end, flanged ends (not shown) may be provided at either ends 110 and 112 of the outer enclosure 108, and to comply with this provision, flanged ends may be formed on each of the end caps 114 and 116 as well. In so doing, a flanged connection interface may be formed between the end caps 114 and 116 and the outer enclosure 108. Alternative connection arrangements, such as those known and applied conventionally and without flanged connection ends are also possible. Given a need, the end caps 114 and 116 may be removed to provide access within the DPF 106.

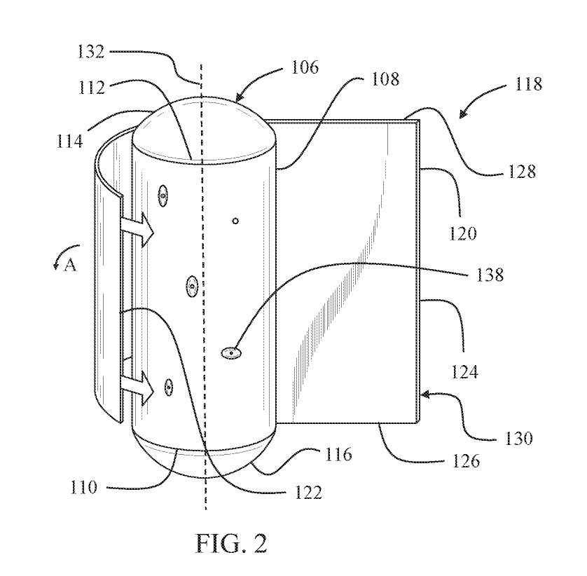

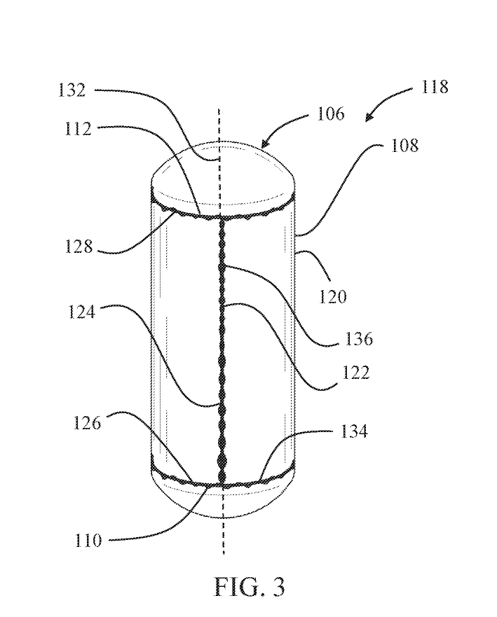

Referring to FIGS. 2 and 3, a generally sequentially occurring repair system 118 and an associated method of repairing the outer enclosure 108 of the DPF 106 is shown and discussed. The repair system 118 includes a generally planar metal sheet (or simply sheet 120). The sheet 120 is planar in configuration and includes a rectangular shape and profile, although other profiles are contemplated, but which depend upon contours, edges, bends, turns, and other characteristic physical features of a surface area of the outer enclosure 108. In effect, the sheet 120 substantially conforms to the surface area of the outer enclosure 108 and includes axial boundaries that when extended across the surface area of the outer enclosure 108, substantially lie in compliance with ends of the outer enclosure 108, at the first axial end 110 and the second axial end 112. Generally, a breadth of the sheet 120 matches with a height of the outer enclosure 108 and a length of the sheet 120 matches with the circumference of the outer enclosure 108. Nevertheless, a reverse configuration having the breadth of the sheet 120 match the circumference of the outer enclosure 108 and the length of the sheet 120 match the height of the outer enclosure 108, is also possible. The sheet 120 is relatively flexible to be wound around the outer enclosure 108, and it is possible that the sheet 120 is able to encompass the surface area of the outer enclosure 108. However, the sheet 120 also possesses a requisite degree of rigidity and strength to withstand deformation. The sheet 120 may be stainless steel, for example, although other flexible materials with appropriate tensile properties may be considered. The sheet 120 includes a sheet periphery 130 with a first lateral edge 122, a second lateral edge 124, a first longitudinal edge 126, and a second longitudinal edge 128.

Referring to FIG. 2, the sheet 120 is shown in a potential assembly position relative to the surface area of the outer enclosure 108 of the DPF 106. The sheet 120 may be first secured to a fixture (not shown), while the outer enclosure 108 may also be secured to another fixture (not shown). A position of the sheet 120 relative to the outer enclosure 108 may be such that the first lateral edge 122 is positioned substantially along the axial direction and an elongation (or axis 132) of the outer enclosure 108. In that manner, it is possible for the first lateral edge 122 of the sheet 120 to meet the surface area of outer enclosure 108 at an interfacial line 136 (FIG. 3) that is generally parallel to the axis 132 of the outer enclosure 108, before a wrapping operation is initiated according to the present disclosure.

Referring to FIG. 3, the sheet 120 is shown in an enveloped state relative to the surface area of the outer enclosure 108, as the sheet 120 is joined to the surface area of the outer enclosure 108 by welding. As the interfacial line 136 meets with the surface area of the outer enclosure 108, the sheet 120 may be wound about the surface area in a direction, A, (FIG. 2) such that the second lateral edge 124 is enfolded to meet with the first lateral edge 122. Also, with the sheet 120's wrap-up in place, the first longitudinal edge 126 is matched with the first axial end 110, and likewise, the second longitudinal edge 128 is matched with the second axial end 112. In that manner, the sheet 120 is able to substantially entirely envelope the surface area of the outer enclosure 108. Weld marks 134 are shown that depict the matched portions of sheet 120 with the surface area of the outer enclosure 108.

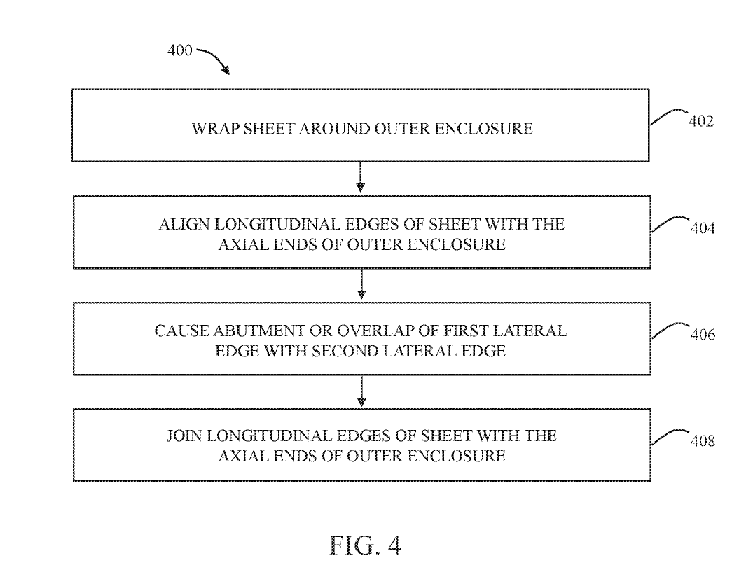

Referring to FIG. 4, a flowchart 400 shows the steps of an exemplary method of repairing the outer enclosure 108 of the DPF 106 according to the aspects of the present disclosure. The flowchart 400 is described in connection with FIGS. 2 and 3. The method starts at step 402.

At step 402, an operator wraps the sheet 120 around the outer enclosure 108 of the DPF 106, and conforms a match of the sheet periphery 130 to the surface area of the outer enclosure 108. The method proceeds to step 404.

At step 404, the operator adjusts and aligns the first longitudinal edge 126 of the sheet 120 with the first axial end 110 of the outer enclosure 108, and the second longitudinal edge 128 of the sheet 120 with the second axial end 112 of the outer enclosure 108. The method proceeds to step 406.

At step 406, the operator ensures one of an abutment or an overlap of the first lateral edge 122 with the second lateral edge 124. The method proceeds to end step 408.

At end step 408, the operator joins the first longitudinal edge 126 of the sheet 120 to the first axial end 110 of the outer enclosure 108 and the second longitudinal edge 128 of the sheet 120 to the second axial end 112 of the outer enclosure 108. Alongside, the operator joins the first lateral edge 122 of the sheet 120 with the second lateral edge 124 of the sheet 120 along an axial length (or the interfacial line 136) of the outer enclosure 108 (FIG. 3). This joining is performed by a welding process.

### INDUSTRIAL APPLICABILITY

During operations, as it is required for DPFs applied in conventional machinery to undergo a regular regeneration process, an operator removes/disassembles the DPF 106 from the engine system 100 and the exhaust cleaning module 104. Thereafter, the operator transfers the DPF 106 to a regeneration facility where annular passages of the cored structure in the DPF 106 is cleared of the blocked soot content, and a DPF regeneration is performed. During the regeneration process, a mishandled DPF 106 may sustain deformation and dents 138 (FIG. 2), although such dings, dents, and deformation, may exist even prior to the removal of the DPF 106 from the engine system 100. As the DPF 106 is only selectively accessible from the inside, the operator is restricted to access the insides of the DPF 106 so as to push a dent outward and restore the outer enclosure 108 to its original shape. Therefore, the operator proceeds with the method of repairing the outer enclosure 108 of the DPF 106, according to the aspects of the present disclosure.

First, the operator positions the outer enclosure 108 of the DPF 106 into a fixture (not shown), while another fixture (not shown) accommodates the sheet 120. These fixtures may be part of machines that are based on conventionally available shell welding units, for example, where one portion of the machine accommodates the outer enclosure 108, while another portion movably accommodates the sheet 120, but relative to the outer enclosure 108. Next, the sheet 120 is brought into contact with the outer enclosure 108 and the operator ensures that the first lateral edge 122 of the sheet 120 abuts against the surface area of the outer enclosure 108 in a manner so as to be parallel to the axis 132 of the outer enclosure 108, along the interfacial line 136. Thereafter, the operator initiates a wrapping process by bringing forth the fixtures, holding the outer enclosure 108 and the sheet 120, in a way so as to ensure that the sheet 120 evenly wraps about the outer enclosure 108. Next, as the wrapping is in progress, the operator ensures an alignment of the first longitudinal edge 126 with the first axial end 110 and the second longitudinal edge 128 with the second axial end 112. Once the sheet 120 is substantially entirely wound about the surface area of the outer enclosure 108, the operator ascertains that the first lateral edge 122 at least meets or overlaps with the second lateral edge 124, as a consequence of the wrapping action. Subsequently, the operator initiates a joining process of the first lateral edge 122 with the second lateral edge 124. This joining operation is characterized by laser welding, although other welding methods, such as TIG (tungsten inert gas) welding, may be applied.

Advantageously, once the sheet 120 is wrapped (FIG. 1) dings and dents 138 of the outer enclosure 108 are suitably hidden, and an aesthetic appeal of the outer enclosure 108 is restored and enhanced. Moreover, a process as obtained by wrapping the sheet 120 about the outer enclosure 108 consumes lesser time as compared to a process that involves the removal of the end caps 114 and 116 and generally emptying the insides of the DPF 106, given a push from the inside of the DPF were recommended to rectify the dents 138. Furthermore, since stainless steel is used, a material finish and appeal of the outward form of the DPF is relatively significantly enhanced and results in an increased and delighted customer base. The use of stainless steel comes with the additional benefits, such as that of having prolonged life and being relatively maintenance free, as well.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A method of repairing an outer enclosure of a diesel particulate filter, the outer enclosure having selective inward access, and having a first axial end and a second axial end, the method comprising:
wrapping a generally planar metal sheet around the outer enclosure, wherein the generally planar metal sheet substantially conforms to a surface area of the outer enclosure and has a sheet periphery with a first lateral edge, a second lateral edge, a first longitudinal edge, and a second longitudinal edge;
aligning the first longitudinal edge of the generally planar metal sheet with the first axial end of the outer enclosure, and aligning the second longitudinal edge of the generally planar metal sheet with the second axial end of the outer enclosure;
causing one of an abutment or an overlap of the first lateral edge with the second lateral edge; and
joining the first longitudinal edge of the generally planar metal sheet to the first axial end of the outer enclosure, the second longitudinal edge of the generally planar metal sheet to the second axial end of the outer enclosure, and the first lateral edge of the generally planar metal sheet with the second lateral edge of the generally planar metal sheet along an axial length of the outer enclosure, wherein the joining is performed by a welding process.
